(19) United States
(12) Patent Application Publication
(10) Pub. No.: US 2015/0175875 A1
(43) Pub. Date: Jun. 25, 2015

(54) Systems and Methods for Improved Subterranean Granular Resistive Heaters

(71) Applicants: Federico G. Gallo, Houston, TX (US); Chen Fang, Houston, TX (US); Nazish Hoda, Houston, TX (US); Michael W. Lin, Bellaire, TX (US); William P. Meurer, Magnolia, TX (US)

(72) Inventors: Federico G. Gallo, Houston, TX (US); Chen Fang, Houston, TX (US); Nazish Hoda, Houston, TX (US); Michael W. Lin, Bellaire, TX (US); William P. Meurer, Magnolia, TX (US)

(21) Appl. No.: 14/518,966

(22) Filed: Oct. 20, 2014

Related U.S. Application Data
(60) Provisional application No. 61/918,603, filed on Dec. 19, 2013.

(51) Int. Cl. C09K 8/592; E21B 43/24

(52) U.S. Cl. CPC C09K 8/592; E21B 43/2401

(57) ABSTRACT

Systems and methods for improved subterranean granular resistive heaters. The methods may include forming a composite granular resistive heating material. These methods may include determining an expected operating range for an environmental parameter for the composite granular resistive heating material within a subterranean formation, selecting a first material, selecting a second material, and/or generating the composite granular resistive heating material from the first material and the second material. The methods may include forming a granular resistive heater. The methods may include determining the expected operating range and/or locating the composite granular resistive heating material within the subterranean formation. The systems may include a composite granular resistive heating material that includes a first material and a second material and that defines a composite functional relationship between an electrical property of the composite granular resistive heating material and the environmental parameter. The composite functional relationship includes a mathematical extremum.

### CROSS-REFERENCE TO RELATED APPLICATION

This application claims the priority benefit of U.S. Provisional Patent Application 61/918,603 filed Dec. 19, 2013 entitled SYSTEMS AND METHODS FOR IMPROVED SUBTERRANEAN GRANULAR RESISTIVE HEATERS, the entirety of which is incorporated by reference herein.

### FIELD

The present disclosure is directed generally to systems and methods for improved subterranean granular resistive heaters, and more particularly to systems and methods that utilize a composite granular resistive heating material that defines a mathematical extremum in an electrical property of the mathematical extremum within an expected operating range of an environmental parameter for the heater.

### BACKGROUND

Certain subterranean formations may include hydrocarbons, such as shale oil, bitumen, and/or kerogen, that may possess material and/or chemical properties that may complicate production of the hydrocarbons from the subterranean formation. For example, a viscosity of the hydrocarbons may be sufficiently high to prevent production (or at least economical production) of the hydrocarbons from the subterranean formation. As another example, it may be desirable to change a chemical composition of the hydrocarbons, such as by decreasing an average molecular weight of the hydrocarbons, prior to production of the hydrocarbons.

To improve production, the hydrocarbons often may be heated within the subterranean formation (i.e., in situ). The heating may decrease the viscosity of the hydrocarbons and/or may speed (and/or initiate) chemical reaction (or decomposition) of the hydrocarbons, thereby permitting economical production of the hydrocarbons from the subterranean formation by flowing from the subterranean formation.

Granular resistive heaters that are constructed from granular resistive heating materials have been utilized to accomplish the heating. The granular resistive heaters may be formed by flowing and/or otherwise locating the granular resistive heating material within the subterranean formation, such as via any suitable injection and/or production well. Subsequently, an electric current may be provided to the granular resistive heaters, with the granular resistive heaters generating heat responsive to receipt of the electric current.

A density of the electric current within the granular resistive heaters may vary significantly from one region to another and/or with time within a given region. The variation may be caused by a variety of factors.

For example, and since the granular resistive heating material may be flowed into the subterranean formation, a uniformity and/or thickness of the granular resistive heating material may vary within the granular resistive heater. The uniformity and/or thickness variation of the granular resistive heating material may produce localized differences in electrical conductivity and/or electrical resistivity of the granular resistive heater.

As another example, a temperature of one region of the granular resistive heater may vary relative to another region of the granular resistive heater. Since the electrical conductivity of the granular resistive heating material may be temperature dependent, the variations in temperature may generate current density variations within the granular resistive heater.

As yet another example, a compressive stress that may be experienced by the granular resistive heating material in one region of the granular resistive heater may vary relative to another region of the granular resistive heater. A compressive stress variation may change a contact resistance among a plurality of granules, or particles, that comprise the granular resistive heater, thereby generating localized electrical resistivity and/or electrical conductivity variations within the granular resistive heater. Variation in compressive stress may be caused by a variety of factors, including pressure that may be applied to the granular resistive heating material by the subterranean formation and/or temperature differences that may generate differences in thermal expansion and/or thermal contraction of the granular resistive heating material.

Regardless of the specific mechanism, variation in current density within the granular resistive heater may cause non-uniform heating of the granular resistive heater by the electric current and/or non-uniform heating of the subterranean formation by the granular resistive heater. Non-uniform heating of the granular resistive heater may be detrimental to overall system performance, may increase an electric power needed to generate a desired level of heating within the subterranean formation, may preclude effective and/or efficient heating of certain regions of the subterranean formation, and/or may damage the granular resistive heater. Thus, there exists a need for systems and methods for improved subterranean granular resistive heaters.

### SUMMARY

A method of forming a composite granular resistive heating material for a subterranean granular resistive heater. The method may comprise determining an expected operating range of an environmental parameter for the composite granular resistive heating material within a subterranean formation. The method also may comprise selecting a first material that defines a first functional relationship between an electrical property of the first material and the environmental parameter. The method also may comprise selecting a second material that defines a second functional relationship between a property of the second material and the environmental parameter. The method also may comprise generating the composite granular resistive heating material from the first material and the second material. The composite granular resistive heating material may define a composite functional relationship between an electrical property of the composite granular resistive heating material and the environmental parameter. The composite functional relationship may define a mathematical extremum within the expected operating range of the environmental parameter.

A method of forming a subterranean granular resistive heater. The method may comprise determining an expected operating range of an environmental parameter for the composite granular resistive heating material within a subterranean formation. The method also may comprise locating a composite granular resistive heating material within the subterranean formation. The composite granular resistive heating material may define a composite functional relationship between an electrical property of the composite granular resistive heating material and the environmental parameter. The composite relationship may define a mathematical extremum within the expected operating range of the environmental parameter.

A composite granular resistive heating material. The composite granular resistive heating material may comprise a first material that defines a first functional relationship between an electrical property of the first material and an environmental parameter for the composite granular resistive heating material when the composite granular resistive heating material is present within a subterranean formation. The composite granular resistive heating material may comprise a second material that defines a second functional relationship between a property of the second material and the environmental parameter. The composite granular resistive heating material may define a composite functional relationship between an electrical property of the composite granular resistive heating material and the environmental parameter. The composite functional relationship may define a mathematical extremum within an expected operating range of the environmental parameter for the composite granular resistive heating material within the subterranean formation.

The foregoing has broadly outlined the features of the present disclosure so that the detailed description that follows may be better understood. Additional features will also be described herein.

### BRIEF DESCRIPTION OF THE DRAWINGS

FIG. 1 is a schematic representation of a subterranean formation that contains a composite granular resistive heating material.

FIG. 2 is a schematic representation of a composite functional relationship between an electrical property of a composite granular resistive heating material and an environmental parameter.

FIG. 3 is a schematic representation of electrical properties of a first material, a second material, and a composite granular resistive heating material as a function of an environmental parameter.

FIG. 4 is a schematic representation of an electrical property of a first material, a property of a second material, and an electrical property of a composite granular resistive heating material as a function of an environmental parameter.

FIG. 5 is a flowchart depicting methods of forming a composite granular resistive heating material.

FIG. 6 is a flowchart depicting methods of forming a subterranean granular resistive heater.

It should be noted that the figures are merely examples and no limitations on the scope of the present disclosure are intended thereby. Further, the figures are generally not drawn to scale, but are drafted for purposes of convenience and clarity in illustrating various aspects of the disclosure.

### DETAILED DESCRIPTION

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

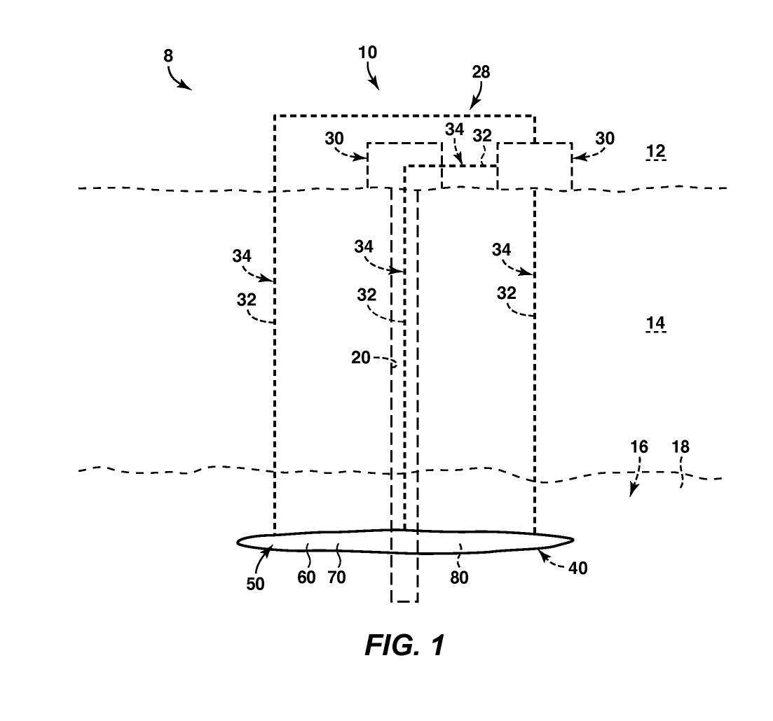

FIG. 1 provides examples of a composite granular resistive heating material 50 that may be located within a subterranean formation 16 and/or that may form a portion of a hydrocarbon production system 8. In general, elements that are likely to be included are illustrated in solid lines, while elements that are optional are illustrated in dashed lines. However, elements that are shown in solid lines may not be essential. Thus, an element shown in solid lines may be omitted without departing from the scope of the present disclosure.

Composite granular resistive heating material 50 may include a first material 60 and a second material 70. First material 60 may define a first functional relationship between an electrical property of first material 60 and an environmental parameter for composite granular resistive heating material 50. First material 60 may define the first functional relationship when composite granular resistive heating material 50 is present within subterranean formation 16. Second material 70 may define a second functional relationship between a property of second material 70 and the environmental parameter. Second material 70 may define the second functional relationship when composite granular resistive heating material 50 is present within subterranean formation 16.

Subterranean granular resistive heating material 50 may be included in a hydrocarbon production system 8 that includes a hydrocarbon well 10. Hydrocarbon well 10, when present, may include a wellbore 20. Wellbore 20 may extend within subterranean formation 16 and/or between a surface region 12 and subterranean formation 16. Subterranean formation 16 may be present within a subsurface region 14 and may include a hydrocarbon 18. Composite granular resistive heating material 50 may be located within subterranean formation 16 to form a subterranean granular resistive heater 40.

A power supply structure 30 may provide an electric current 32 to subterranean granular resistive heater 40 via one or more electrical conduits 34. Power supply structure 30 also may receive at least a portion of the electric current from subterranean granular resistive heater 40 via the one or more electrical conduits 34, thereby forming a power supply circuit 28 for subterranean granular resistive heater 40.

A portion of power supply circuit 28, such as power supply structure 30 and/or electrical conduit(s) 34 may be included in and/or may form a portion of hydrocarbon well 10. However, a portion of power supply circuit 28 may be spaced apart and/or separate from hydrocarbon well 10.

In operation, power supply circuit 28 may provide electric current 32 from power supply structure 30 to subterranean granular resistive heater 40 via electrical conduits 34. Electric current 32 may flow through subterranean granular resistive heater 40 (and/or through composite granular resistive heating material 50 thereof).

A resistivity and/or conductivity of subterranean granular resistive heater 40 may be selected such that flow of electric current 32 through subterranean granular resistive heater 40 generates heat within subterranean granular resistive heater 40. The generated heat may be conveyed from subterranean granular resistive heater 40 to subterranean formation 16 via any suitable heat transfer mechanism, such as conduction, to heat subterranean formation 16. Hydrocarbons 18 may include viscous hydrocarbons, shale oil, bitumen, and/or kerogen. Heating of subterranean formation 16 may reduce a viscosity of hydrocarbons 18 and permit hydrocarbons 18 to be produced (or economically produced) from subterranean formation 16.

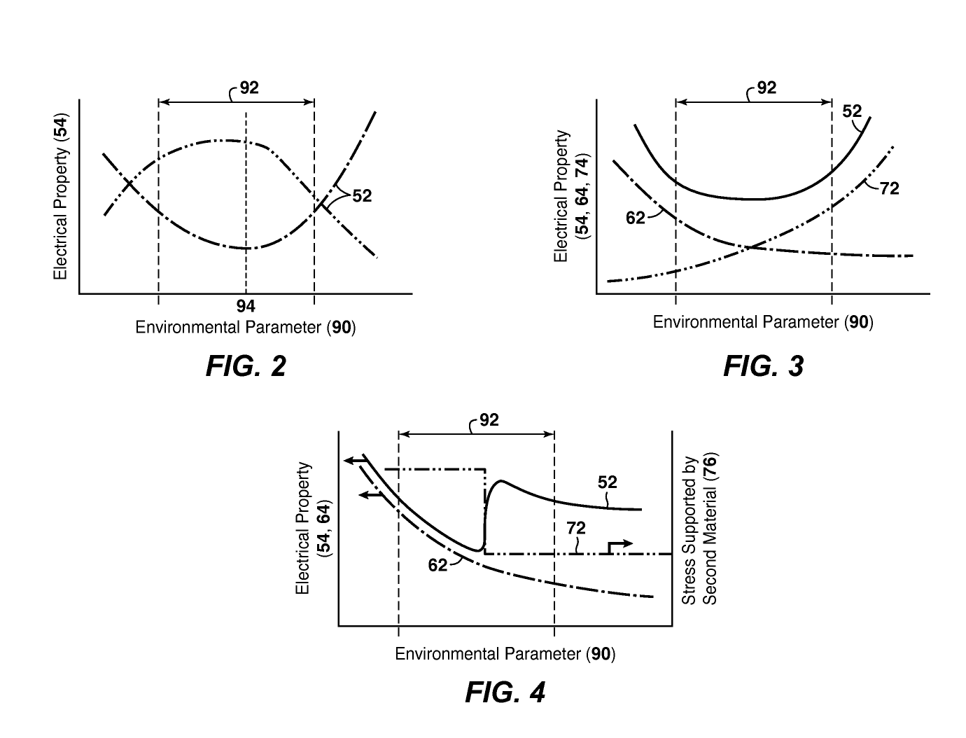

Composite granular resistive heating material 50 may define a composite functional relationship between an electrical property of the composite granular resistive heating material and the environmental parameter. A composition and/or relative proportion of first material 60 and/or second material 70 may be selected such that the composite functional relationship of composite granular resistive heating material 50 defines a mathematical extremum within an expected operating range of the environmental parameter. Thus, composite granular resistive heating material 50 may be designed, formulated, configured, and/or selected to maintain the environmental parameter for composite granular resistive heating material 50 within the expected operating range. This is discussed in more detail with reference to FIGS. 2-4.

The composite functional relationship may include any suitable functional relationship that defines the mathematical extremum within the expected operating range of the environmental parameter. The composite functional relationship may include and/or be a local minimum, a local maximum, a global minimum, and/or a global maximum in electrical property of the composite granular resistive heating material within the expected operating range of the environmental parameter. The composite functional relationship may be non-monotonic within the expected operating range of the environmental parameter.

During operation of hydrocarbon production system 8 and/or hydrocarbon well 10, the environmental parameter may vary and/or cycle within the expected operating range. The composite functional relationship may or may not be (at least substantially) reproducible from one cycle to the next. The composite functional relationship may exhibit a hysteresis region during cycling of the environmental parameter.

The environmental parameter may include and/or be any suitable environmental parameter, or condition, that may be experienced by composite granular resistive heating material 50 when present within subterranean formation 16.

The environmental parameter may include a temperature of composite granular resistive heating material 50. When the environmental parameter includes the temperature of composite granular resistive heating material 50, the expected operating range may extend over a range of temperatures that may be bounded by a minimum temperature and/or by a maximum temperature. The minimum temperature may be at least 250° C., at least 300° C., at least 350° C., at least 400° C., at least 450° C., at least 500° C., at least 550° C., at least 600° C., at least 650° C., at least 700° C., at least 750° C., and/or at least 800° C. Any of the aforementioned ranges may be within a range that includes or is bounded by any of the preceding examples. The maximum temperature may be less than 1250° C., less than 1200° C., less than 1150° C., less than 1100° C., less than 1050° C., less than 1000° C., less than 950° C., less than 900° C., less than 850° C., less than 800° C., less than 750° C., and/or less than 700° C. Any of the aforementioned ranges may be within a range that includes or is bounded by any of the preceding examples.

The environmental parameter may include a compressive stress on composite granular resistive heating material 50 when present within subterranean formation 16. When the environmental parameter includes the compressive stress on composite granular resistive heating material 50, the expected operating range may extend over a range of compressive stresses that may be bounded by a minimum compressive stress and/or by a maximum compressive stress. The minimum compressive stress may be at least 1 megapascal (MPa), at least 2 MPa, at least 3 MPa, at least 4 MPa, at least 5 MPa, at least 7.5 MPa, at least 10 MPa, at least 12.5 MPa, at least 15 MPa, at least 20 MPa, at least 25 MPa, at least 30 MPa, at least 35 MPa, at least 40 MPa, at least 50 MPa, and/or at least 60 MPa. Any of the aforementioned ranges may be within a range that includes or is bounded by any of the preceding examples. The maximum compressive stress may be less than 100 MPa, less than 90 MPa, less than 80 MPa, less than 70 MPa, less than 60 MPa, less than 50 MPa, less than 40 MPa, and/or less than 30 MPa. Any of the aforementioned ranges may be within a range that includes or is bounded by any of the preceding examples.

Composite granular resistive heating material 50, including first material 60 and/or second material 70 of the composite granular resistive heating material 50, may include any suitable material, composition, and/or chemical composition. Composite granular resistive heating material 50 may include an electrically conductive material, such as calcined petroleum coke, carbon black, graphite, and/or metal shavings. Composite granular resistive heating material 50 may include a non-conductive material, such as cement, ceramic particles, clay, and/or sand. Composite granular resistive heating material 50 may include a thermally stable material and/or a thermally unstable material. Composite granular resistive heating material 50 may include a material with a negative coefficient of thermal expansion, such as cubic zirconium tungstate. Composite granular resistive heating material 50 may include a semiconducting material, a polymer, and/or a powder.

When composite granular resistive heating material 50 includes cement, the cement may include a low temperature cement that may be selected to decompose during heating of composite granular resistive heating material 50 within subterranean formation 16. The low temperature cement may degrade at any suitable degradation temperature. The degradation temperature may be less than 900° C., less than 850° C., less than 800° C., less than 750° C., less than 700 ° C., less than 650 ° C., less than 600° C., less than 550° C., and/or less than 500° C. Any of the aforementioned ranges may be within a range that includes or is bounded by any of the preceding examples. The degradation temperature also may be greater than 400° C., greater than 450° C., greater than 500° C., greater than 550° C., greater than 600° C., greater than 650° C., greater than 700° C., greater than 750° C., and/or greater than 800° C. Any of the aforementioned ranges may be within a range that includes or is bounded by any of the preceding examples.

When composite granular resistive heating material 50 includes cement, the cement may include a high temperature cement that may be selected to be stable and/or not to degrade and/or decompose during heating of composite granular resistive heating material 50 within subterranean formation 16. The high temperature cement may be stable and/or may not degrade at temperatures that are less than a threshold degradation temperature. The threshold degradation temperature may be at least 800° C., at least 850° C., at least 900° C., at least 950° C., at least 1000° C., at least 1050° C., at least 1100° C., at least 1150° C., at least 1200° C., at least 1250° C., at least 1300° C., at least 1350° C., at least 1400° C., at least 1450° C., and/or at least 1500° C. Any of the aforementioned ranges may be within a range that includes or is bounded by any of the preceding examples.

When composite granular resistive heating material 50 includes the high temperature cement, composite granular resistive heating material 50 also may include a filler material. The filler material may be selected to thermally degrade during operation of subterranean granular resistive heater 40. The filler material also may be selected to have a negative coefficient of thermal expansion.

The electrical property of first material 60 may include and/or be any suitable electrical property that, when first material 60 is combined with second material 70, produces and/or generates the composite functional relationship for composite granular resistive heating material 50. The electrical property of first material 60 may include an electrical resistivity of first material 60. The electrical property of first material 60 may include an electrical conductivity of first material 60.

The first functional relationship may include, produce, and/or be a monotonic increase in the electrical property of first material 60 with an increase of the environmental parameter within the expected operating range of the environmental parameter. The first functional relationship may include, produce, and/or be a monotonic decrease in the electrical property of first material 60 with an increase of the environmental parameter within the expected operating range of the environmental parameter. The first functional relationship may include, produce, and/or be a discontinuous increase in the electrical property of first material 60 with an increase of the environmental parameter within the expected operating range of the environmental parameter. The first functional relationship may include, produce, and/or be a discontinuous decrease in the electrical property of first material 60 with an increase of the environmental parameter within the expected operating range of the environmental parameter. The first functional relationship may include, produce, and/or be a, or an at least substantially, constant electrical property of the first material within the expected operating range of the environmental parameter.

The property of second material 70 may include and/or be any suitable property that, when second material 70 is combined with first material 60, produces and/or generates the composite functional relationship for composite granular resistive heating material 50. The property of second material 70 may include an electrical resistivity of second material 70. The property of second material 70 may include an electrical conductivity of second material 70. The property of second material 70 may include a material phase of second material 70. The property of second material 70 may include a rigidity of second material 70. The property of second material 70 may include a volume of second material 70.

The second functional relationship may include, produce, and/or be a monotonic increase in the property of second material 70 with an increase of the environmental parameter within the expected operating range of the environmental parameter. The second functional relationship may include, produce, and/or be a monotonic decrease in the property of second material 70 with an increase of the environmental parameter within the expected operating range of the environmental parameter. The second functional relationship may include, produce, and/or be a discontinuous increase in the property of second material 70 with an increase of the environmental parameter within the expected operating range of the environmental parameter. The second functional relationship may include, produce, and/or be a discontinuous decrease in the property of second material 70 with an increase of the environmental parameter within the expected operating range of the environmental parameter.

The second functional relationship may include, produce, and/or be a mathematical extremum in the property of second material 70 within the expected operating range of the environmental parameter. The second functional relationship may include, produce, and/or be a local minimum in the property of second material 70 within the expected operating range of the environmental parameter. The second functional relationship may include, produce, and/or be a global minimum in the property of second material 70 within the expected operating range of the environmental parameter. The second functional relationship may include, produce, and/or be a local maximum in the property of second material 70 within the expected operating range of the environmental parameter. The second functional relationship may include, produce, and/or be a global maximum in the property of second material 70 within the expected operating range of the environmental parameter. The second functional relationship may include, produce, and/or be a, or an at least substantially, constant property of the second material within the expected operating range of the environmental parameter.

Composite granular resistive heating material 50 may include a third material 80. Third material 80 may define a third functional relationship between a property of the third material and the environmental parameter. The property of the third material may include and/or be any suitable property, including those that are discussed with reference to the property of the first material and/or with reference to the property of the second material. The third functional relationship may include and/or be any suitable functional relationship, including those that are discussed with reference to the first functional relationship and/or the second functional relationship.

First material 60, second material 70, and/or third material 80 may comprise any suitable portion, fraction, or volume fraction of composite granular resistive heating material 50. First material 60, second material 70, and/or third material 80 individually may comprise at least 1 volume percent, at least 2 volume percent, at least 3 volume percent, at least 4 volume percent, at least 5 volume percent, at least 7.5 volume percent, at least 10 volume percent, at least 15 volume percent, at least 20 volume percent, at least 25 volume percent, at least 30 volume percent, at least 40 volume percent, at least 50 volume percent, at least 60 volume percent, at least 70 volume percent, at least 80 volume percent, and/or at least 90 volume percent of composite granular resistive heating material 50. Any of the aforementioned ranges may be within a range that includes or is bounded by any of the preceding examples. First material 60, second material 70, and/or third material 80 individually may comprise less than 99 volume percent, less than 97.5 volume percent, less than 95 volume percent, less than 90 volume percent, less than 85 volume percent, less than 80 volume percent, less than 75 volume percent, less than 70 volume percent, less than 65 volume percent, less than 60 volume percent, less than 50 volume percent, less than 40 volume percent, less than 30 volume percent, less than 20 volume percent, and/or less than 10 volume percent of composite granular resistive heating material 50. Any of the aforementioned ranges may be within a range that includes or is bounded by any of the preceding examples.

First material 60, second material 70, and third material 80 collectively may comprise any suitable portion, fraction, or volume fraction of an overall composition of composite granular resistive heating material 50. First material 60, second material 70, and third material 80 together may comprise at least 50 volume percent, at least 60 volume percent, at least 70 volume percent, at least 80 volume percent, at least 90 volume percent, at least 92.5 volume percent, at least 95 volume percent, at least 97.5 volume percent, and/or at least 99 volume percent of composite granular resistive heating material 50. Any of the aforementioned ranges may be within a range that includes or is bounded by any of the preceding examples.

Composite granular resistive heating material 50 may define any suitable morphology and/or relative (spatial) orientation between first material 60 and second material 70. The morphology and/or relative orientation may be defined prior to composite granular resistive heating material 50 being located within subterranean formation 16, subsequent to composite granular resistive heating material 50 being located within subterranean formation 16, and/or subsequent to composite granular resistive heating material 50 being utilized to heat subterranean formation 16.

Composite granular resistive heating material 50 may include and/or be a mixture of first material 60 and second material 70. The mixture may include and/or be a mixture of granules and/or particles. Composite granular resistive heating material 50 may comprise a plurality of granules and/or particles, with each granule and/or particle including both first material 60 and second material 70. First material 60 may cover and/or coat second material 70. Second material 70 may cover and/or coat first material 60.

FIGS. 2-4 provide schematic representations of composite functional relationships 52, first functional relationships 62, and/or second functional relationships 72. In FIGS. 2-4, composite functional relationships 52, first functional relationships 62, and/or second functional relationships 72 are plotted as a function of an environmental parameter 90. FIGS. 2-4 also illustrate an expected operating range 92 of environmental parameter 90.

Composite functional relationships 52 of FIGS. 2-4 are examples of the composite functional relationships that may be defined by composite granular resistive heating material 50 of FIG. 1. First functional relationships 62 of FIGS. 3-4 are examples of the first functional relationships that may be defined by first material 60 of FIG. 1. Second functional relationships 72 of FIGS. 3-4 are examples of the second functional relationships that may be defined by second material 70 of FIG. 1. Expected operating ranges 92 of environmental parameter 90 of FIGS. 2-4 are examples of the expected operating ranges of the environmental parameters that may be experienced by composite granular resistive heating material 50 when present within hydrocarbon well 10 and/or hydrocarbon production system 8 of FIG. 1.

The various functional relationships are schematic in nature and are provided for illustration purposes only. Other functional relationships may be utilized with and/or defined by the disclosed systems and methods. Similarly, the discussed more specific examples are for illustration purposes only, and thus are non-exclusive examples. Other more specific examples, such as those that are disclosed herein, may be utilized with and/or defined by the disclosed systems and methods.

FIG. 2 is a plot of two different composite functional relationships 52 that may be exhibited by an electrical property 54 of a composite granular resistive heating material (such as composite granular resistive heating material 50 of FIG. 1). Electrical property 54 may define a local and/or global minimum within expected operating range 92 (as illustrated in dash-dot lines). Electrical property 54 may define a local and/or global maximum within expected operating range 92 (as illustrated in dash-dot-dot lines).

Electrical property 54 may include and/or be an electrical resistivity of the composite granular resistive heating material. When electrical property 54 is the electrical resistivity of the composite granular resistive heating material, the composite granular resistive heating material may be formulated, designed, configured, and/or selected such that the electrical resistivity defines the minimum within expected operating range 92 (as illustrated in dash-dot lines).

Environmental parameter 90 may be a temperature of the composite granular resistive heating material. Generally, decreases in the electrical resistivity of the composite granular resistive heating material may permit more electric current to flow through the composite granular resistive heating material, increasing a temperature of the composite granular resistive heating material. Conversely, increases in the electrical resistivity of the composite granular resistive heating material may restrict current flow through the composite granular resistive heating material, decreasing the temperature of the composite granular resistive heating material.

In operation, the composite granular resistive heating material may be heated to expected operating range 92. As the temperature of the composite granular resistive heating material is increased to operating range 92 the decrease in electrical resistivity with increasing temperature may permit efficient and/or rapid heating of the composite granular resistive heating material. However, and once the temperature reaches a threshold level (as indicated at 94), further heating of the composite granular resistive heating material may produce an increase in the resistivity of the composite granular resistive heating material. The increase in resistivity may decrease the temperature of the composite granular resistive heating material and/or may cause the composite granular resistive heating material to maintain a temperature that may be within expected operating range 92 and/or that may be near threshold level 94.

Environmental parameter 90 may be a compressive stress that may be exerted on the composite granular resistive heating material within the subterranean formation. Traditional subterranean granular resistive heaters that do not utilize the disclosed systems and methods may exhibit a monotonic decrease in resistivity with an increase in the compressive stress that is exerted on the subterranean granular resistive heater. As the resistivity decreases, the temperature may increase, which may cause thermal expansion of the traditional subterranean granular resistive heater. The thermal expansion may further increase the compressive stress, further decreasing the resistivity and increasing the temperature in a cycle that may preclude effective operation of the traditional subterranean granular resistive heater.

In contrast to traditional subterranean granular resistive heaters, and as illustrated in dash-dot lines in FIG. 2, the composite granular resistive heating material disclosed herein may exhibit a local and/or global minimum in resistivity as a function of compressive stress. The minimum may decrease a potential for the above-described compressive stress-resistivity cycle. The minimum may permit more effective operation of subterranean granular resistive heaters that include the composite granular resistive heating material disclosed herein by causing the subterranean granular resistive heater to operate within expected operating range 92 and/or at, or near, threshold level 94 of the compressive stress.

Electrical property 54 may include and/or be an electrical conductivity of the composite granular resistive heating material. When electrical property 54 is the electrical conductivity of the composite granular resistive heating material, the composite granular resistive heating material may be formulated, designed, configured, and/or selected such that the electrical conductivity defines the maximum within expected operating range 92 (as illustrated in dash-dot-dot lines in FIG. 2). The maximum in the electrical conductivity within expected operating range 92 may cause a subterranean granular resistive heater that includes the composite granular resistive heating material to operate within expected operating range 92 and/or at, or near, threshold level 94 in much the same manner as is discussed with reference to the resistivity of the composite granular resistive heating material.

FIG. 3 is a schematic representation of a first functional relationship 62 of an electrical property 64 of a first material and a second functional relationship 72 of an electrical property 74 of a second material. The first material and the second material may be combined to generate a composite granular resistive heating material. First functional relationship 62 and second functional relationship 72 may combine to generate a composite functional relationship 52 in an electrical property 54 of the composite granular resistive heating material. Composite functional relationship 52 may define a minimum within expected operating range 92 of environmental parameter 90. The minimum may cause a subterranean granular resistive heater that includes the composite granular resistive heating material to operate within expected operating range 92.

In FIG. 3, environmental parameter 90 may be a temperature of the composite granular resistive heating material. Electrical property 64 of the first material may be an electrical resistivity of the first material. Electrical property 74 of the second material may be an electrical resistivity of the second material. Electrical property 54 of the composite granular resistive heating material may be an electrical resistivity of the composite granular resistive heating material.

As illustrated, first functional relationship 62 may include, produce, and/or be a decrease (optionally a monotonic decrease) in the electrical resistivity of the first material with increasing temperature within expected operating range 92. Second functional relationship 72 may include, produce, and/or be an increase (optionally a monotonic increase) in the electrical resistivity of the second material with increasing temperature within expected operating range 92.

In FIG. 3, environmental parameter 90 also may be a compressive stress on the composite granular resistive heating material. Electrical property 64 of the first material may be an electrical resistivity of the first material. Electrical property 74 of the second material may be an electrical resistivity of the second material. Electrical property 54 of the composite granular resistive heating material may be an electrical resistivity of the composite granular resistive heating material.

As illustrated, first functional relationship 62 may include, produce, and/or be a decrease (optionally a monotonic decrease) in the electrical resistivity of the first material with increasing compressive stress within expected operating range 92. Second functional relationship 72 may include, produce, and/or be an increase (optionally a monotonic increase) in the electrical resistivity of the second material with increasing compressive stress within expected operating range 92.

FIG. 4 is a schematic representation of a first functional relationship 62 of an electrical property 64 of a first material and a second functional relationship 72 of a property 76 of a second material. The first material and the second material may be combined to generate a composite granular resistive heating material. First functional relationship 62 and second functional relationship 72 may combine to generate a composite functional relationship 52 in an electrical property 54 of the composite granular resistive heating material. Composite functional relationship 52 may define a minimum within expected operating range 92 of environmental parameter 90. The minimum may cause a subterranean granular resistive heater that includes the composite granular resistive heating material to operate within expected operating range 92.

In FIG. 4, environmental parameter 90 may be a temperature of the composite granular resistive heating material. Electrical property 64 of the first material may be an electrical resistivity of the first material. Electrical property 74 of the second material may be a rigidity of the second material. Electrical property 54 of the composite granular resistive heating material may be an electrical resistivity of the composite granular resistive heating material.

As illustrated in dash-dot lines, first functional relationship 62 may include, produce, and/or be a decrease (optionally a monotonic decrease) in the electrical resistivity of the first material with increasing temperature within expected operating range 92. As illustrated in dash-dot-dot lines, second functional relationship 72 may include, produce, and/or be a decrease, a monotonic decrease, or a step change in the rigidity of the second material with increasing temperature within expected operating range 92. The decrease in rigidity may include a softening of the second material, a flowing of the second material, or a phase change of the second material. The decrease in the rigidity of the second material may decrease a compressive stress that acts upon the first material. The decrease in compressive stress may decrease granule-to-granule contact area and/or forces within the first material, thereby generating the illustrated minima in the electrical resistivity of the composite granular resistive heating material (as illustrated in solid lines).

In FIG. 4, environmental parameter 90 may be a compressive stress on the composite granular resistive heating material. Electrical property 64 of the first material may be the electrical resistivity of the first material. Electrical property 74 of the second material may be the rigidity of the second material. Electrical property 54 of the composite granular resistive heating material may be the electrical resistivity of the composite granular resistive heating material.

As illustrated, first functional relationship 62 may include, produce, and/or be a decrease (optionally a monotonic decrease) in the electrical resistivity of the first material with increasing compressive stress within expected operating range 92. Second functional relationship 72 may include, produce, and/or be a decrease, a monotonic decrease, or a step change in the rigidity of the second material with increasing compressive stress within expected operating range 92. The decrease in rigidity may include a softening of the second material, a flowing of the second material, or a phase change of the second material. The decrease in the rigidity of the second material may decrease a compressive stress that acts upon the first material. This decrease in compressive stress may decrease granule-to-granule contact area and/or forces within the first material, thereby generating the illustrated minima in the electrical resistivity of the composite granular resistive heating material (as illustrated in solid lines).

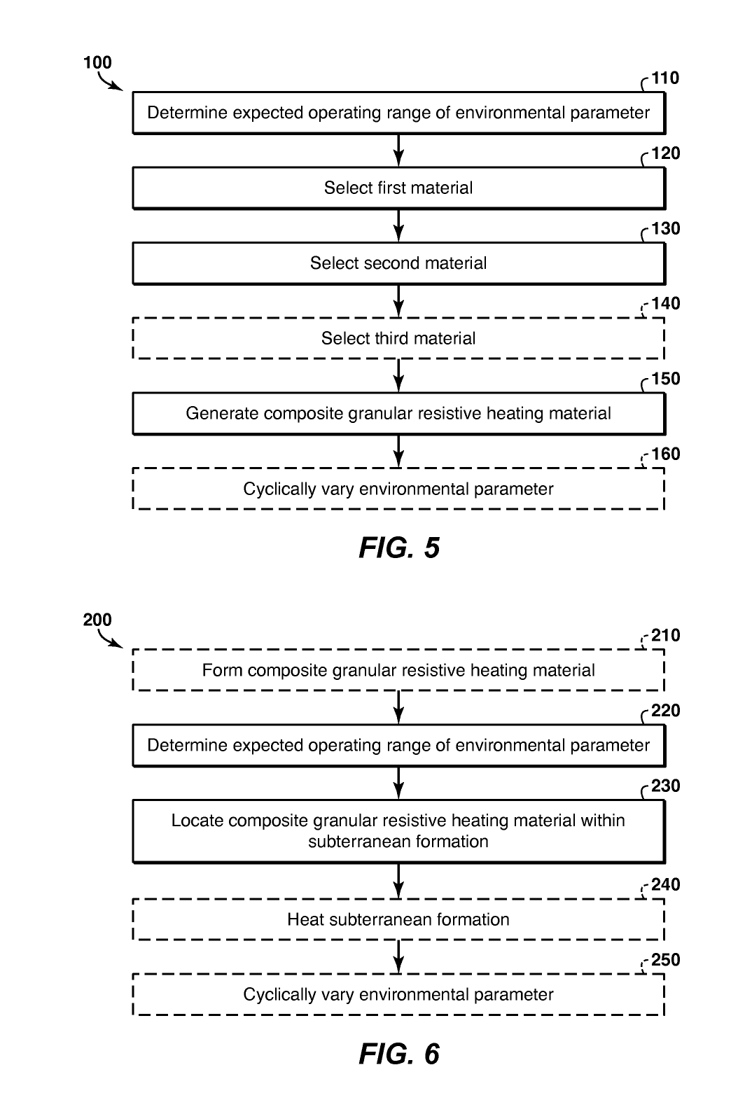

FIG. 5 is a flowchart depicting methods 100 of forming a composite granular resistive heating material. Methods 100 may include determining an expected operating range of an environmental parameter for the granular resistive heating material at 110, selecting a first material at 120, and/or selecting a second material at 130. Methods 100 may include selecting a third material at 140, generating a composite granular resistive heating material at 150, and/or cyclically varying the environmental parameter at 160.

Determining the expected operating range of the environmental parameter for the granular resistive heating material at 110 may include determining any suitable operating parameter for the composite granular resistive heating material. The composite granular resistive heating material may experience, be exposed to, and/or be subjected to the operating parameter when the composite granular resistive heating material is present within the subterranean formation. The determining at 110 may include measuring, calculating, selecting, estimating, and/or otherwise obtaining the expected operating range.

The determining at 110 may include characterizing a composition of the subterranean formation and selecting the expected operating range based, at least in part, on the composition of the subterranean formation. The determining at 110 may include modeling the subterranean formation and selecting the expected operating range of the environmental parameter based, at least in part, on the modeling.

The determining at 110 may include selecting a desired operating temperature range for the subterranean granular resistive heater within the subterranean formation, and the expected operating range of the environmental parameter may be based, at least in part, on (or may be) the desired operating temperature range. The determining at 110 may include determining an expected compressive stress on the composite granular resistive heating material within the subterranean formation, and the expected operating range of the environmental parameter may be based, at least in part, on (or may be) the expected compressive stress.

Selecting the first material at 120 may include selecting any suitable first material. The first material may define a first functional relationship between an electrical property of the first material and the environmental parameter. Examples of the first material, the first functional relationship, and the electrical property of the first material are disclosed herein. The selecting at 120 may include selecting the first material based, at least in part, upon the first functional relationship. The selecting at 120 may include selecting such that the composite granular resistive heating material defines a desired composite functional relationship subsequent to the generating at 150.

Selecting the second material at 130 may include selecting any suitable second material. The second material may define a second functional relationship between a property of the second material and the environmental parameter. Examples of the second material, the second functional relationship, and the property of the second material are disclosed herein. The selecting at 130 may include selecting the second material based, at least in part, upon the second functional relationship. The selecting at 130 may include selecting such that the composite granular resistive heating material defines the desired composite functional relationship subsequent to the generating at 150.

Selecting the third material at 140, when utilized, may include selecting any suitable third material. The third material may define a third functional relationship between a property of the third material and the environmental parameter. Examples of the third material, the third functional relationship, and the property of the third material are disclosed herein. The selecting at 140 may include selecting the third material based, at least in part, upon the third functional relationship. The selecting at 140 may include selecting such that the composite granular resistive heating material defines the desired composite functional relationship subsequent to the generating at 150.

Generating the composite granular resistive heating material at 150 may include generating the composite granular resistive heating material in any suitable manner. The generating at 150 may include generating such that the composite granular resistive heating material defines a composite functional relationship between an electrical property of the composite granular resistive heating material and the environmental parameter. The composite functional relationship may define a mathematical extremum within the expected operating range of the environmental parameter. Examples of the mathematical extremum and the electrical property of the granular resistive heating material are disclosed herein.

The generating at 150 may include mixing and/or combining the first material, the second material, and/or the third material to form the composite granular resistive heating material. The mixing and/or combining may include mixing and/or combining such that the composite granular resistive heating material defines discrete and/or separate regions, zones, domains, particles, and/or granules of the first material, the second material, and/or the third material. The mixing and/or combining may include mixing and/or combining to generate a homogeneous mixture. The mixing and/or combining may include mixing and/or combining to generate a heterogeneous mixture.

The generating at 150 may include forming granules that each may include the first material and the second material, which may also include the third material. The generating at 150 may include coating the first material with the second material and/or with the third material. The generating at 150 may include coating the second material with the first material and/or with the third material. The generating at 150 may include coating the third material with the first material and/or with the second material.

The first material, the second material, and/or the third material individually may comprise any suitable portion, or fraction, of the composite granular resistive heating material. The generating at 150 may include generating such that the first material, the second material, and/or the third material individually comprise at least 1 volume percent, at least 2 volume percent, at least 3 volume percent, at least 4 volume percent, at least 5 volume percent, at least 7.5 volume percent, at least 10 volume percent, at least 15 volume percent, at least 20 volume percent, at least 25 volume percent, at least 30 volume percent, at least 40 volume percent, at least 50 volume percent, at least 60 volume percent, at least 70 volume percent, at least 80 volume percent, and/or at least 90 volume percent of the composite granular resistive heating material. Any of the aforementioned ranges may be within a range that includes or is bounded by any of the preceding examples. The generating at 150 may include generating such that the first material, the second material, and/or the third material individually comprise less than 97.5 volume percent, less than 95 volume percent, less than 90 volume percent, less than 85 volume percent, less than 80 volume percent, less than 75 volume percent, less than 70 volume percent, less than 65 volume percent, less than 60 volume percent, less than 50 volume percent, less than 40 volume percent, less than 30 volume percent, less than 20 volume percent, and/or less than 10 volume percent of the composite granular resistive heating material. Any of the aforementioned ranges may be within a range that includes or is bounded by any of the preceding examples.

The first material, the second material, and the third material collectively may comprise any suitable portion, or fraction, of the composite granular resistive heating material. The generating at 150 may include generating such that the first material, the second material, and/or the third material together (or collectively) comprise at least 50 volume percent, at least 60 volume percent, at least 70 volume percent, at least 80 volume percent, at least 90 volume percent, at least 92.5 volume percent, at least 95 volume percent, at least 97.5 volume percent, or at least 99 volume percent of the composite granular resistive heating material. Any of the aforementioned ranges may be within a range that includes or is bounded by any of the preceding examples.

Cyclically varying the environmental parameter at 160 may include repeatedly and/or cyclically varying the environmental parameter within the expected operating range of the environmental parameter. The cyclically varying at 160 may include cyclically varying during a plurality of environmental parameter cycles. The cyclically varying at 160 may include repeatedly increasing and subsequently decreasing the environmental parameter.

When methods 100 include the cyclically varying at 160, the selecting at 120, the selecting at 130, and/or the selecting at 140 may include selecting such that the composite functional relationship may be reproducible, or at least substantially reproducible, during each of the plurality of environmental parameter cycles. When methods 100 include the cyclically varying at 160, the selecting at 120, the selecting at 130, and/or the selecting at 140 may include selecting such that the composite functional relationship may not be reproducible during each of the plurality of environmental parameter cycles.

When methods 100 include the cyclically varying at 160, the selecting at 120, the selecting at 130, and/or the selecting at 140 may include selecting such that the composite functional relationship may not be reproducible during any of the plurality of environmental parameter cycles. When methods 100 include the cyclically varying at 160, the selecting at 120, the selecting at 130, and/or the selecting at 140 may include selecting such that the composite functional relationship exhibits, or defines, a hysteresis region during each of the plurality of environmental parameter cycles.

FIG. 6 is a flowchart depicting methods 200 of forming a granular resistive heater. Methods 200 may include forming a composite granular resistive heating material at 210, determining an expected operating range of an environmental parameter for the granular resistive heating material at 220, and/or locating the composite granular resistive heating material within a subterranean formation at 230. Methods 200 further may include heating the subterranean formation at 240 and/or cyclically varying the environmental parameter at 250.

Forming the composite granular resistive heating material at 210 may include forming the composite granular resistive heating material in any suitable manner. The forming at 210 may include mixing at least a first material and a second material to form the composite granular resistive heating material. The forming at 210 may include performing any suitable portion of methods 100 to generate the composite granular resistive heating material. The forming at 210 may include performing at least the selecting at 120, the selecting at 130, and the generating at 150 of methods 100.

Determining the expected operating range of the environmental parameter for the granular resistive heating material at 220 may include determining the expected operating range in any suitable manner. The determining at 220 may be at least substantially similar to the determining at 110, which is discussed herein.

Locating the composite granular resistive heating material within the subterranean formation at 230 may include locating the composite granular resistive heating material in any suitable manner. The locating at 230 may include flowing the composite granular resistive heating material into the subterranean formation via a wellbore that extends within the subterranean formation and/or that extends between a surface region and the subterranean formation. The flowing may include flowing a slurry that may include the composite granular resistive heating material and a liquid, such as water.

The composite granular resistive heating material defines a composite functional relationship between an electrical property of the composite granular resistive heating material and the environmental parameter. The composite functional relationship defines a mathematical extremum within the expected operating range of the environmental parameter. Examples of the electrical property of the granular resistive heating material, the mathematical extremum, and the environmental parameter are disclosed herein.

Heating the subterranean formation at 240 may include heating the subterranean formation with the subterranean granular resistive heater and/or with the composite granular resistive heating material. The heating at 240 may include providing an electric current to the composite granular resistive heating material to generate heat within the composite granular resistive heating material and/or to heat the subterranean formation. When the environmental parameter is a temperature of the composite granular resistive heating material, the heating at 240 may include heating to an operating temperature that may be within the expected operating range of the temperature.

Cyclically varying the environmental parameter at 250 may include cyclically varying in any suitable manner. The cyclically varying at 250 may be at least substantially similar to the cyclically varying at 160, which is discussed herein.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, the order of the blocks may vary from the illustrated order in the flow diagram, including with two or more of the blocks (or steps) occurring in a different order and/or concurrently.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numeral ranges provided. Accordingly, these terms should be interpreted as indicating that insubstantial or inconsequential modifications or alterations of the subject matter described and are considered to be within the scope of the disclosure.

### INDUSTRIAL APPLICABILITY

The systems and methods disclosed herein are applicable to the oil and gas industry.

The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are novel and non-obvious. Other combinations and subcombinations of features, functions, elements and/or properties may be claimed through amendment of the present claims or presentation of new claims in this or a related application. Such amended or new claims, whether different, broader, narrower, or equal in scope to the original claims, are also regarded as included within the subject matter of the present disclosure.

1. A method of forming a composite granular resistive heating material for a subterranean granular resistive heater, the method comprising:
determining an expected operating range of an environmental parameter for the composite granular resistive heating material within a subterranean formation;
selecting a first material that defines a first functional relationship between an electrical property of the first material and the environmental parameter;
selecting a second material that defines a second functional relationship between a property of the second material and the environmental parameter; and
generating the composite granular resistive heating material from the first material and the second material, wherein the composite granular resistive heating material defines a composite functional relationship between an electrical property of the composite granular resistive heating material and the environmental parameter, and the composite functional relationship defines a mathematical extremum within the expected operating range.

2. The method of claim 1, wherein the generating includes generating such that the first material and the second material each comprise at least 5 volume percent of the composite granular resistive heating material.

3. The method of claim 1, wherein the generating includes generating such that the first material and the second material together comprise at least 90 volume percent of the composite granular resistive heating material.

4. The method of claim 1, wherein the generating includes at least one of:
(i) mixing the first material and the second material to form the composite granular resistive heating material;
(ii) combining the first material and the second material to form the composite granular resistive heating material;
(iii) forming granules that each include the first material and the second material;
(iv) coating the first material with the second material to form the composite granular resistive heating material; and
(v) coating the second material with the first material to form the composite granular resistive heating material.

5. The method of claim 4, further comprising cyclically varying the environmental parameter within the expected operating range during a plurality of environmental parameter cycles.

6. A method of forming a subterranean granular resistive heater, the method comprising:
determining an expected operating range of an environmental parameter for the composite granular resistive heating material within a subterranean formation; and
locating a composite granular resistive heating material within the subterranean formation, wherein the composite granular resistive heating material defines a composite functional relationship between an electrical property of the composite granular resistive heating material and the environmental parameter, and wherein the composite relationship defines a mathematical extremum within the expected operating range.

7. The method of claim 6, further comprising heating the subterranean formation with the composite granular resistive heating material by providing an electric current to the composite granular resistive heating material to heat the subterranean formation.

8. The method of claim 6, wherein the determining includes characterizing a composition of the subterranean formation and selecting the expected operating range based, at least in part, on the composition.

9. The method of claim 6, wherein the mathematical extremum includes at least one of:
(i) a local minimum;
(ii) a global minimum;
(iii) a local maximum; and
(iv) a global maximum.

10. The method of claim 6, wherein the environmental parameter includes a temperature of the composite granular resistive heating material within the subterranean formation, and further wherein the expected operating range is between 500 and 1000 degrees Celsius.

11. The method of claim 6, wherein the environmental parameter includes a compressive stress on the composite granular resistive heating material within the subterranean formation, and further wherein the expected operating range is between 3 and 70 megapascals.

12. The method of claim 6, wherein the method further includes forming the composite granular resistive heating material, wherein the forming includes:
selecting a first material that defines a first functional relationship between an electrical property of the first material and the environmental parameter;
selecting a second material that defines a second functional relationship between a property of the second material and the environmental parameter; and
generating the composite granular resistive heating material from the first material and the second material.

13. A composite granular resistive heating material, comprising:
a first material that defines a first functional relationship between an electrical property of the first material and an environmental parameter for the composite granular resistive heating material when the composite granular resistive heating material is present within a subterranean formation; and
a second material that defines a second functional relationship between a property of the second material and the environmental parameter;
wherein the composite granular resistive heating material defines a composite functional relationship between an electrical property of the composite granular resistive heating material and the environmental parameter, and
wherein the composite functional relationship defines a mathematical extremum within an expected operating range of the environmental parameter for the composite granular resistive heating material within the subterranean formation.

14. The material of claim 13, wherein the mathematical extremum includes at least one of:
(i) a local minimum;
(ii) a global minimum;
(iii) a local maximum; and
(iv) a global maximum.

15. The material of claim 13, wherein the composite granular resistive heating material includes at least two of an electrically conductive material, calcined petroleum coke, carbon black, graphite, metal shavings, a non-conductive material, cement, ceramic particles, clay, sand, a thermally stable material, a thermally unstable material, a material with a negative coefficient of thermal expansion, cubic zirconium tungstate, a semiconducting material, a polymer, and a powder.

16. The material of claim 13, wherein the composite granular resistive heating material includes calcined petroleum coke and a cement.

17. The material of claim 16, wherein the cement is a low temperature cement that is selected to decompose during heating of the composite granular resistive heating material.

18. The material of claim 16, wherein the cement is a high temperature cement, wherein the composite granular resistive heating material further includes a filler material, and further wherein the filler material is at least one of a thermally degradable material and a material with a negative coefficient of thermal expansion.

19. The material of claim 13, wherein the environmental parameter is a temperature of the composite granular resistive heating material within the subterranean formation, wherein the electrical property of the first material is an electrical resistivity of the first material, wherein the electrical property of the composite granular resistive heating material is an electrical resistivity of the composite granular resistive heating material, and wherein the mathematical extremum is at least one of a local minimum and a global minimum.

20. The material of claim 19, wherein the first functional relationship is a decrease in the electrical resistivity of the first material with increasing temperature within the expected operating range, wherein the property of the second material is an electrical resistivity of the second material, and further wherein the second functional relationship is an increase in the electrical resistivity of the second material with increasing temperature within the expected operating range.

21. The material of claim 19, wherein the first functional relationship is a decrease in the electrical resistivity of the first material with increasing temperature within the expected operating range, wherein the property of the second material is a rigidity of the second material, and further wherein the second functional relationship is a decrease in the rigidity of the second material with increasing temperature within the expected operating range.

22. The material of claim 13, wherein the environmental parameter is a compressive stress on the composite granular resistive heating material within the subterranean formation, wherein the electrical property of the first material is an electrical resistivity of the first material, wherein the electrical property of the composite granular resistive heating material is an electrical resistivity of the composite granular resistive heating material, and wherein the mathematical extremum is at least one of a local minimum and a global minimum.

23. The material of claim 22, wherein the first functional relationship is a decrease in the electrical resistivity of the first material with increasing compressive stress within the expected operating range, wherein the property of the second material is an electrical resistivity of the second material, and wherein the second functional relationship is an increase in the electrical resistivity of the second material with increasing compressive stress within the expected operating range.

24. The material of claim 22, wherein the first functional relationship is a decrease in the electrical resistivity of the first material with increasing compressive stress within the expected operating range, wherein the property of the second material is a rigidity of the second material, and wherein the second functional relationship is a decrease in the rigidity of the second material with increasing compressive stress within the expected operating range.

25. The material of claim 13, wherein the first material and the second material each comprise at least 5 volume percent of the composite granular resistive heating material.

26. The material of claim 13, wherein the first material and the second material together comprise at least 90 volume percent of the composite granular resistive heating material.

27. The material of claim 13, wherein the composite granular resistive heating material is a mixture of the first material and the second material.

28. The material of claim 13, wherein the composite granular resistive heating material includes granules that each include the first material and the second material.

29. The material of claim 13, wherein one of the first material and the second material forms a coating that covers the other of the first material and the second material.

30. A hydrocarbon well, comprising:
a wellbore that extends between a surface region and a subterranean formation; and
a subterranean granular resistive heater formed from the composite granular resistive heating material of claim 13, wherein the composite granular resistive heating material is within the subterranean formation.
